(19) United States
(12) Patent Application Publication
(10) Pub. No.: US 2014/0051287 A1
(43) Pub. Date: Feb. 20, 2014

(54) SAFETY ELECTRIC SOCKET

(71) Applicant: SHENG-HSIN LIAO, NEW TAIPEI CITY (TW)

(72) Inventor: SHENG-HSIN LIAO, NEW TAIPEI CITY (TW)

(21) Appl. No.: 13/589,145

(22) Filed: Aug. 19, 2012

(51) Int. Cl. H01R 13/648

(52) U.S. Cl. 439/607.01

(57) ABSTRACT

A safety electric socket includes a main body, a cap, a first slider, a second slider, a first elastic element and a second elastic element. The main body has a housing and the cap covers the housing and has at least two slots. The first slider has a first shield portion, a first plate portion and a first ramp portion. The second slider has a second shield portion, a second plate portion and a second ramp portion. Different compartments are formed between each of the sliders. The first and second sliders are stacked movably and the second ramp portion rests on top of the first plate portion while the first ramp portion rests on top of the second plate portion. The first and second elastic elements are disposed between the first and second sliders and the housing respectively to help the first and second sliders conceal conduction units.

### BACKGROUND

1. Field of the Invention

The instant disclosure relates to a safety electric socket; in particular, to a safety electric socket preventing electrical shot from improper insertion.

2. Description of Related Art

Electric products are widely used in the public and private domains. In order to power the increasing number of electric products, the appearance of electric sockets has increased altogether. Most of the conventional electric sockets do not have safety protection so curious children may accidentally insert conductive material to the live sockets and suffer electric shock.

The known safety electric sockets prevent the aforementioned accidents and the structure thereof mostly comprises a shell, sliders and a seat. Two sliders are stacked on top of each other and disposed in the shell. An elastic member provides resilience to the sliders, thus concealing the socket to avoid improper insertion. However, the known safety electric sockets have bulky structure because of the parallel stacking of the sliders.

### SUMMARY

The object of the instant disclosure is to provide a safety electric socket with lower structural profile and can be made of a variety of materials.

According to one exemplary embodiment of the instant disclosure, the safety electric socket comprises a main body with a housing, a cap with at least a pair of slots covering the main body, a first slider, a first elastic element, a second slider, and a second elastic element. The first slider includes a first shield portion, a first plate portion and a first ramp portion with a first contacting face. A first prong passage is formed between the first shield portion and the first plate portion and a hole is formed between the first plate portion and the first ramp portion. The second slider includes a second shield portion, a second plate portion and a second ramp portion with a second ramp face. A second prong passage is formed between the second shield portion and the second plate portion. The first and second elastic elements are embedded in the first and second slider respectively and flex outward toward the opposite side of the housing. The second slider passes through the hole of the first slider and the second shield portion rests on top of the first plate portion. On the other hand, the first ramp portion rests on the second shield portion of the second slider. That is to say the first and second sliders are stacked alternatively.

The instant disclosure has the advantages of preventing electric shock by accidental insertion of conductive materials to a socket. The alternative stacking of the first and second sliders also results in lighter structural profile. Furthermore, the first and second elastic elements are combined with the first and second sliders by insert molding so the elastic elements and sliders can be made of different materials. The instant disclosure further comprises two auxiliary springs. One of the auxiliary springs is disposed between the first elastic element and the wall of the housing to reinforce the resilience and recovery of the first elastic element. Likewise, the other one of the auxiliary springs serves the same function yet is disposed between the second elastic element and the wall of the housing.

In order to further understand the instant disclosure, the following embodiments are provided along with illustrations to facilitate the appreciation of the instant disclosure; however, the appended drawings are merely provided for reference and illustration, without any intention to be used for limiting instant disclosure.

### BRIEF DESCRIPTION OF THE DRAWINGS

FIG. 1 shows an exploded diagram of a safety electric socket in accordance with a first embodiment of the instant disclosure.

FIG. 2 shows a perspective view of a safety electric socket in accordance with the first embodiment of the instant disclosure.

FIG. 3 shows a cross sectional view of a safety electric socket in accordance with the first embodiment of the instant disclosure.

FIG. 4 is a cross sectional view illustrating a plug inserted to a safety electric socket in accordance with the first embodiment of the instant disclosure.

FIG. 5 is a cross sectional view illustrating a conductive stick inserted to a safety electric socket in accordance with the first embodiment of the instant disclosure.

FIG. 6 shows an exploded diagram of a safety electric socket in accordance with a second embodiment of the instant disclosure.

FIG. 7 shows a perspective view of a safety electric socket in accordance with a third embodiment of the instant disclosure.

FIG. 8 shows a perspective view of a safety electric socket in accordance with a fourth embodiment of the instant disclosure.

FIG. 9 shows a perspective view of a safety electric socket in accordance with a fifth embodiment of the instant disclosure.

FIG. 10 shows a perspective view of a safety electric socket in accordance with a sixth embodiment of the instant disclosure.

FIG. 11 shows an exploded view of a safety electric socket in accordance with a seventh embodiment of the instant disclosure.

FIG. 12 shows an exploded view of a safety electric socket in accordance with an eighth embodiment of the instant disclosure.

FIG. 13 shows an exploded view of a safety electric socket in accordance with a ninth embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

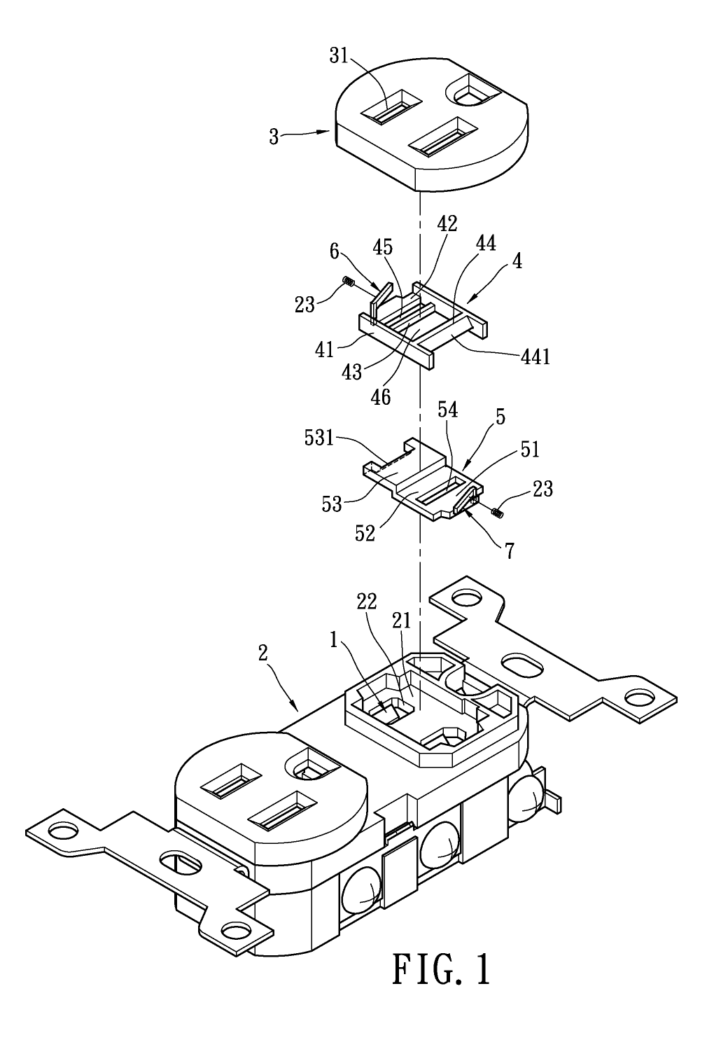

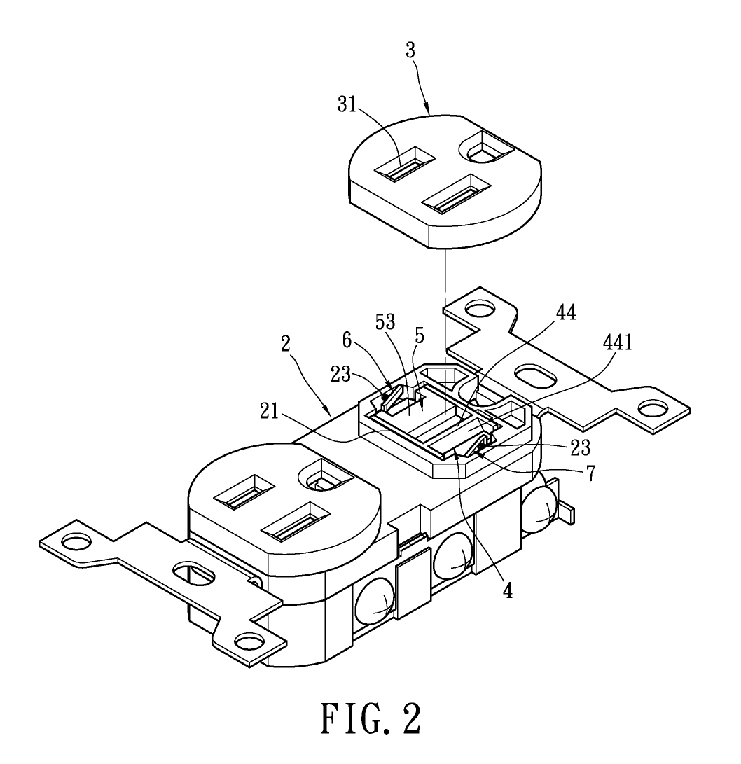

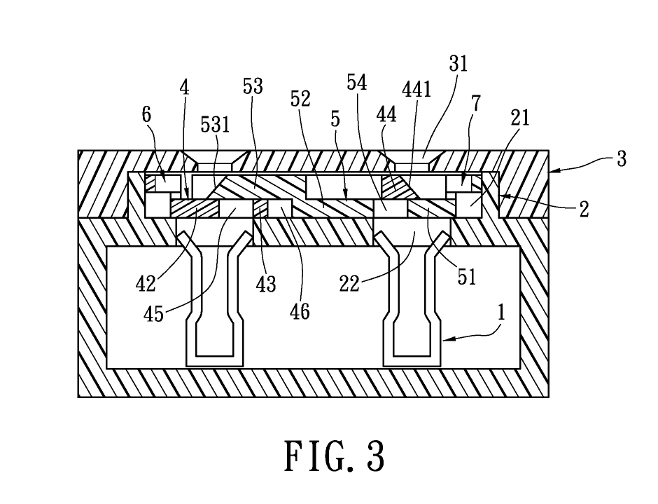

Please refer to FIGS. 1-3. The instant disclosure provides a safety electric socket which is disposed on top of conduction units 1 of an electric socket. The safety electric socket comprises a main body 2, a cap 3, a first slider 4, a second slider 5, a first elastic element 6 and a second elastic element 7. The main body 2 is preferably made of a plastic material and the structure thereof is not limited thereto. The main body 2 includes at least one housing 21 which opens at one end. The housing 21 has at least two receiving holes 22 conforming to each pair of the conduction units 1.

The cap 3 is preferably made of a plastic material and the structure thereof is not limited thereto. The cap 3 includes at least two slots 31 allowing conventional prongs to travel through. The first slider 4, second slider 5, first elastic element 6 and second elastic element 7 are arranged in the housing 21 and sealed by the cap 3. The slots 31 are conformingly aligned with the conduction units 1. The cap 3 is secured on the main body 2 by tenon, adhesion, bolt, or ultrasonic welding.

The first slider 4 is preferably made of a plastic material. The first slider 4 resembles substantially in a shape of a ladder. The first slider 4 includes two boards 41 acting as stringers, a first shield portion 42, a first plate portion 43 and a first ramp portion 44. The first shield portion 42, first plate portion 43 and first ramp portion 44 are disposed between the two boards 41 separately to define different compartments. The first shield portion 42 and the first plate portion 43 form a first prong passage 45 in between and the first prong passage 45 matches the shape of conventional prongs. The first ramp portion 44 has a contacting face 441 and is arranged above the level of the first shield portion 42 and first plate portion 43. A hole 46 is formed between the first plate portion 43 and first ramp portion 44 for the second slider 5 to pass through.

The second slider 5 is preferably made of a plastic material. The second slider 5 includes a second shield portion 51, a second plate portion 52 and a second ramp portion 53 with a second ramp face 531. The second shield portion 51 and the second plate portion 52 are connected yet a second prong passage 54 is formed there-between. The second prong passage 54 together with the first prong passage 45 fit a pair of conventional prongs. The second ramp portion 53 connects the second plate portion 52 via a riser to form a step-like structure.

The first elastic element 6 can be formed by extending upward from the first shield portion 42. The first elastic element 6 is a long piece of elastic body stretching outward slantingly. However, the first elastic element 6 is preferably fixed on the first slider 4 by insert molding. In other words, one end of the first elastic element 6 is embedded in the first slider 4 and therefore the first elastic element 6 and the first slider 4 can be made of different materials.

Likewise, the second elastic element 7 can be formed by extending upward from the second shield portion 51 yet preferably fixed on the second slider 5 by insert molding. Furthermore, the attachment of the first and second elastic elements 6, 7 to the first and the second sliders 4, 5 can be achieved by different ways. The first and second elastic element 6, 7 can also be springs.

To assemble the safety electric socket, the second slider 5 passes through the hole 46 of the first slider 4 from underneath so the first slider 4 and the second slider 5 are stacked alternatively. The second ramp portion 53 rests on top of the first plate portion 43 and contacts the first shield portion 42. On the other hand, the first ramp portion 44 rests on top of the second shield portion 51. The housing 21 accommodates the assembled first and second slider 4, 5 which are movably arranged. The first and second elastic elements 6, 7, attached to the first and second slider 4, 5, flex outward toward the housing 21 in opposite direction. The cap 3 covers the housing 21 and seals the open end thereof. The first and second ramp face 441, 531 are conformingly positioned to the two slots 31 respectively.

When a plug is inserted to the slots 31, prongs press against the first and second ramp faces 441, 531 simultaneously, thus pushing the first and second sliders 4, 5 shifting towards opposite direction to reveal the two receiving holes 22. When the plug is removed, the first and second elastic elements 6, 7 provide the recovery force to the first and second sliders 4, 5 so the receiving holes 22 are concealed again.

The instant disclosure may further comprise two auxiliary springs 23 to facilitate recovery of the first and second sliders 4, 5. One of the two auxiliary springs 23 is disposed between the first elastic element 6 and the housing 21 while the other one is between the second elastic element 7 and the housing 21. The auxiliary springs 23 enhance the resilience of the first and second elastic elements 6, 7, thus facilitating the first and second sliders 4, 5 to return to a close state.

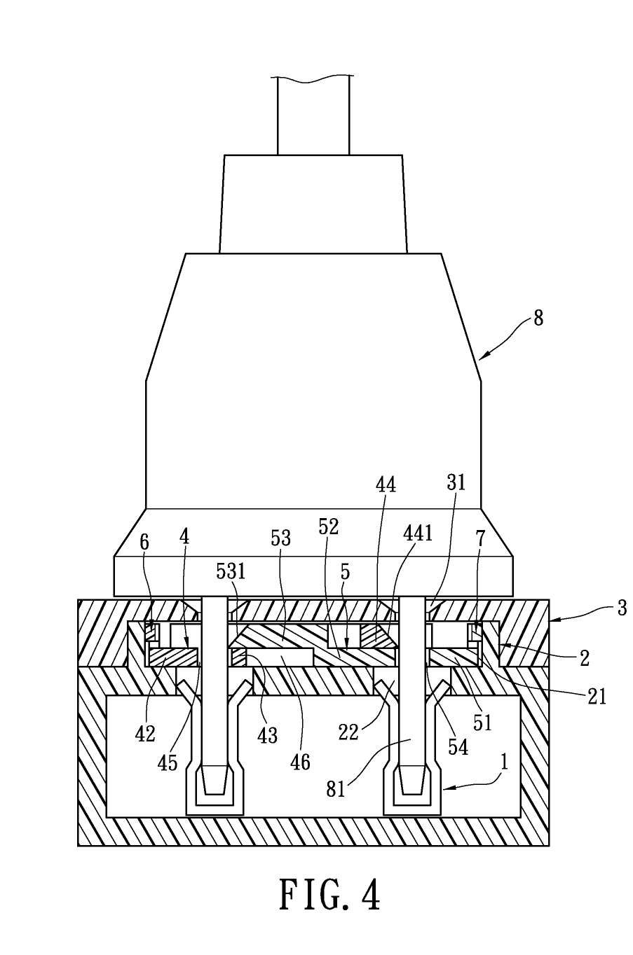

Please refer to FIG. 4. When inserting a plug 8 to the safety electric socket, prongs 81 pass through the slots 31 simultaneously and further travel to the housing 21. The prongs 81 press against the first and second ramp faces 441, 531 respectively and the first and second sliders 4, 5 are then pushed apart and moving toward opposite direction, thus the first and second prong passages 45, 54 are revealed. The prongs 81 travel further and contact the conduction units 1.

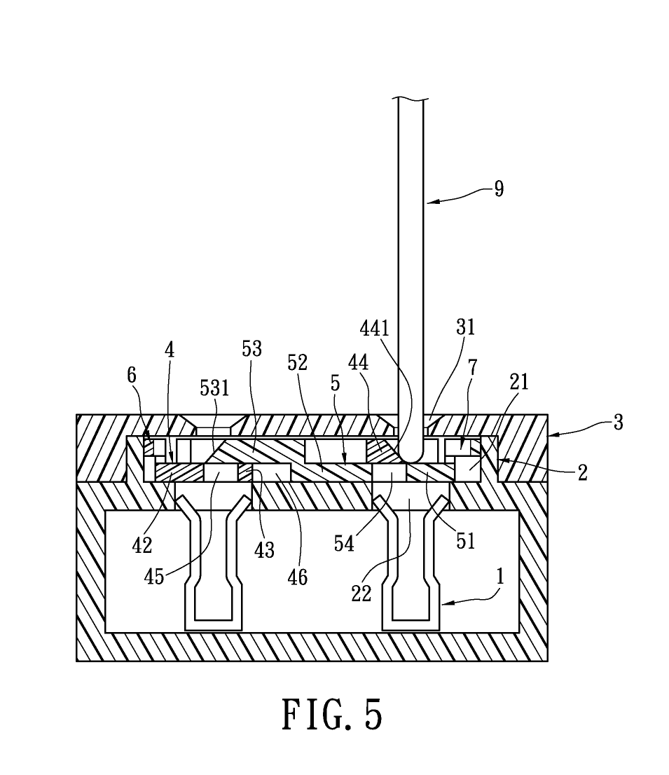

Please refer to FIG. 5. A metallic stick 9 passes through the cap 3 by one of the slots 31 to the housing 21. The metallic stick 9 presses against the contacting face 441 and the first slider 4 shifts slightly. However, the second shield portion 51 blocks the metallic stick 9 because the second slider 5 remains still. Hence the metallic stick 9 cannot not travel trough the second prong passage 54 nor the receiving holes 22. Likewise, if the metallic stick 9 goes through the other one of the slots 31 and presses against the contacting face 531, the first shield portion 42 blocks the entrance as well. Therefore, the metallic stick 9 cannot have contact with the conduction unit 1.

The instant disclosure prevents electrical shock by accidental insertion of a conductive material instead of plugs. Also, the first and second sliders 4, 5 are stacked alternatively to reduce the structural profile. The first and second elastic elements 6, 7 can be embedded in the first and second sliders 4, 5 respectively so the materials of the elastic elements and the sliders can be different.

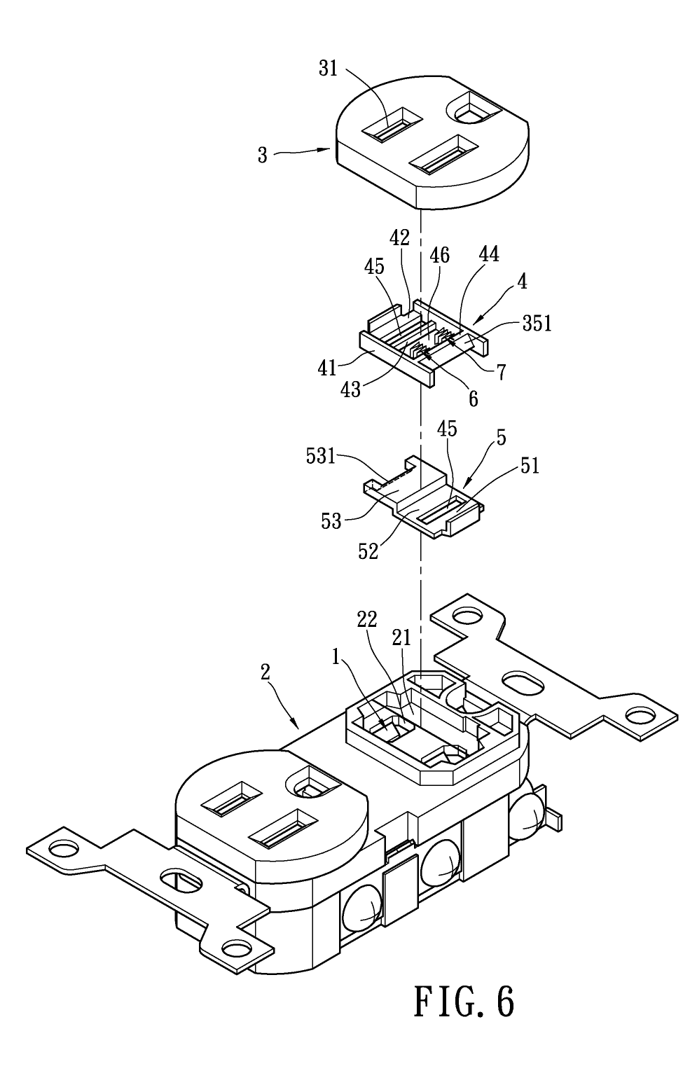

Please refer to FIG. 6 of a second embodiment of the instant disclosure. The first and second elastic elements 6, 7 are insert-molded on the first ramp portion 44 of the first slider 4. The first and second elastic elements 6, 7 are made of an elastic material with a plurality of folds. After assembly, the first and second elastic elements 6, 7 are flanked by the first and second ramp portion 44, 53. The first and second elastic element 6, 7 servers the same purpose as aforementioned. Likewise, the first and second elastic element 6, 7 can be insert-molded on the second ramp portion 53 and flex outward toward the first ramp portion 44.

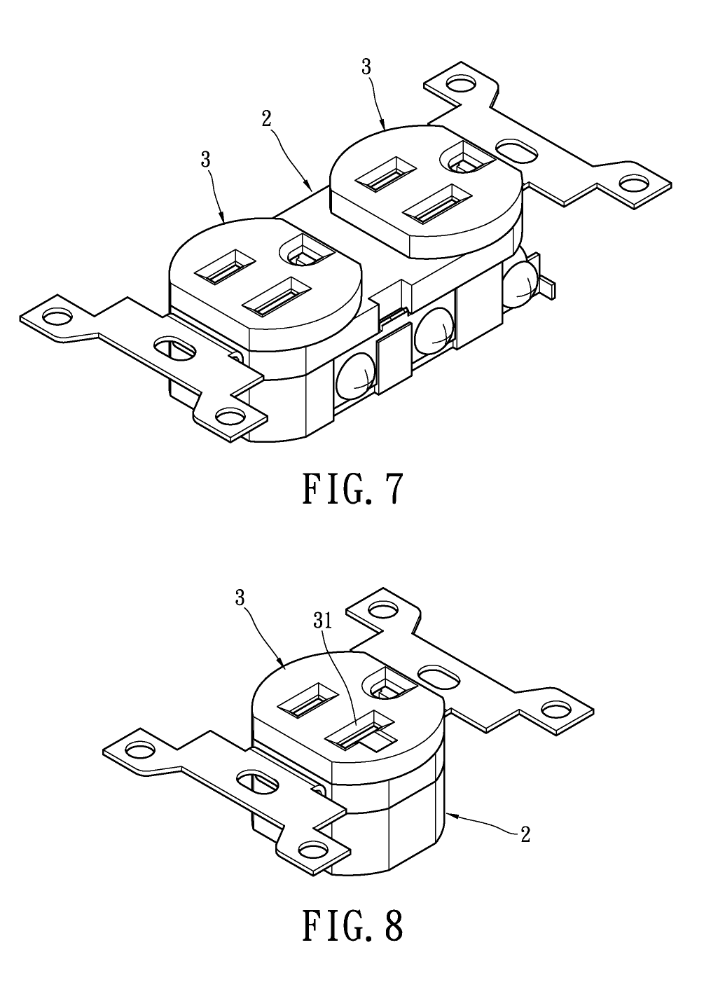

Please refer to FIG. 7 of a third embodiment of the instant disclosure. The cap 3 and the main body 2 are one piece.

Please refer to FIG. 8 of a fourth embodiment of the instant disclosure. The safety electric socket has a single socket and the shape of the slots 31 varies.

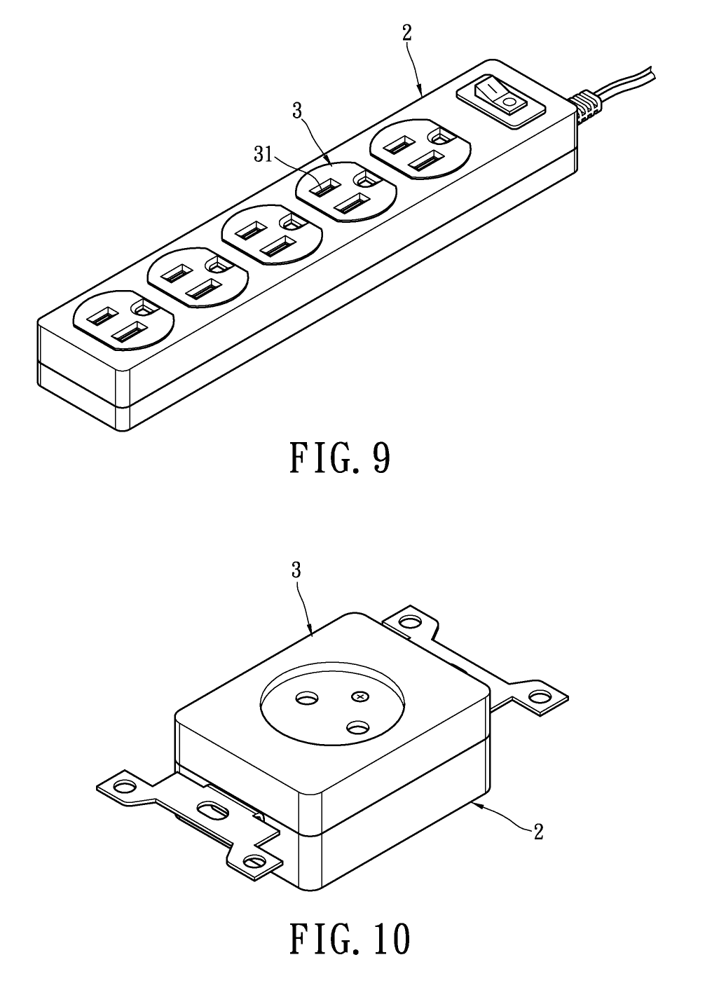

Please refer to FIG. 9 of a fifth embodiment of the instant disclosure. The safety electric socket has a plurality of sockets aligned on one unit.

Please refer to FIG. 10 of a sixth embodiment of the instant disclosure. The safety electric socket is a different type; for example, Europlug.

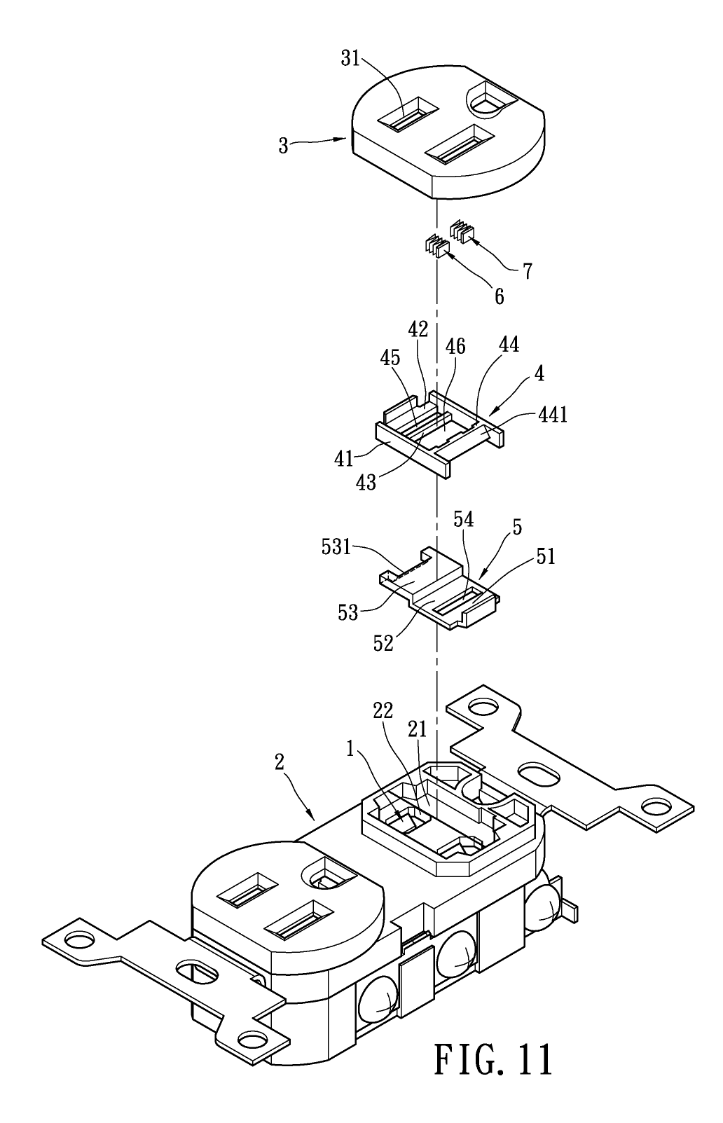

Please refer to FIG. 11 of a seventh embodiment of the instant disclosure. The first and second elastic element 6, 7 are engaged with the first ramp portion 44 by tenon. The same engagement can also be applied between the first and second elastic element 6, 7 and the second ramp portion 53.

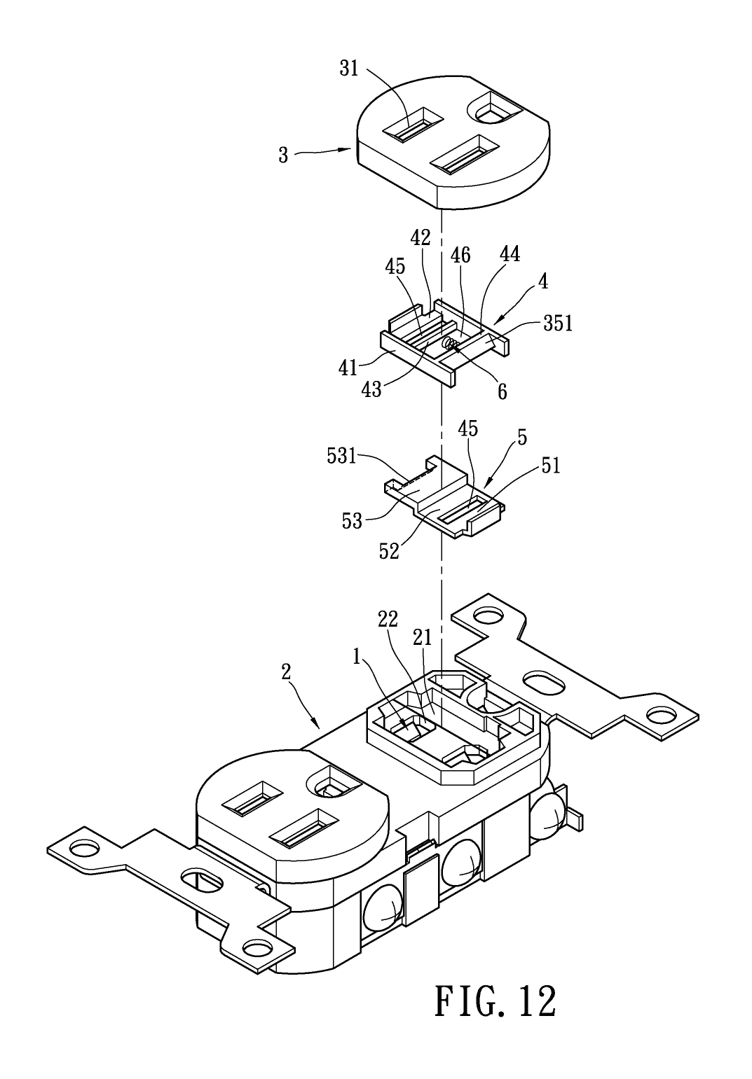

Please refer to FIG. 12 of an eighth embodiment of the instant disclosure. The safety electric socket comprises only one single elastic element 6 and the elastic element 6 can be a spring. The elastic element 6 is disposed on the first or second ramp portion 44, 53 and flanked there-between.

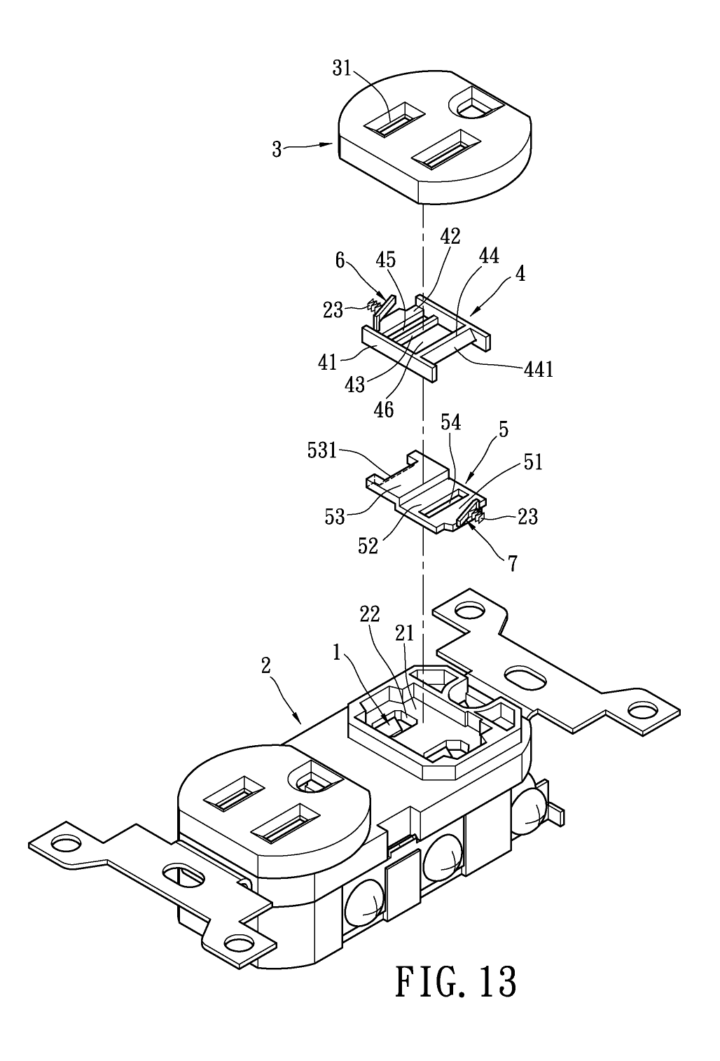

Please refer to FIG. 13 of a ninth embodiment of the instant disclosure. One of the auxiliary springs 23 and the first elastic element 6 are structurally one piece. The same structural feature applies to the other one of the auxiliary springs 23 and the second elastic element 7.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A safety electric socket comprising:
a main body with a housing;
a cap including at least two slots and covering the main body;
a first slider including a first shield portion, a first plate portion and a first ramp portion,
wherein a first prong passage is arranged between the first shield portion and the first plate portion,
wherein a hole is arranged between the first plate portion and the first ramp portion,
wherein the first ramp portion has a first ramp face arranged thereon;
a first elastic element disposed on the first slider;
a second slider including a second shield portion, a second plate portion and a second ramp portion,
wherein a second prong passage is arranged between the second shield portion and the second plate portion,
wherein the second ramp portion has a second ramp face arranged thereon; and
a second elastic element disposed on the second slider;
wherein the first and the second sliders are stacked alternatively with the second slider passing through the hole of the first slider, resting on top of the first plate portion, and in contact with the first shield portion,
wherein the first ramp portion is arranged on top of the second shield portion,
wherein the elastic element is flexible outward toward the second slider to allow the first and second sliders movably disposed in the housing, and the first and second ramp faces conform the position of the slots respectively.

2. The safety electric socket according to claim 1, further comprising two auxiliary springs disposed between the first and second elastic elements and the housing respectively.

3. The safety electric socket according to claim 2, wherein each of the two auxiliary springs form a one piece structure with the corresponding elastic element respectively.

4. The safety electric socket according to claim 1, wherein the first elastic element is embedded in the first slider.

5. The safety electric socket according to claim 1, wherein the second elastic element is embedded in the second slider.

6. The safety electric socket according to claim 1, wherein the first slider includes two boards and the first shield portion, the first plate portion and the first ramp portion are there-between and the first ramp portion is arranged above the level of the first shield portion and the first plate portion.

7. The safety electric socket according to claim 6, wherein the second ramp portion connects to the second plate portion via a riser to form a step-like structure.

8. The safety electric socket according to claim 1, wherein the first and second elastic elements are made of long elastic bodies extending slantingly from the first and second elastic elements respectively.

9. The safety electric socket according to claim 1, wherein the housing includes at least two slots conformingly above at least two conduction units.

10. The safety electric socket according to claim 1, wherein the first and second elastic elements are springs.

11. A safety electric socket comprising:
a main body with a housing;
a cap including at least two slots and covering the main body;
a first slider including a first shield portion, a first plate portion and a first ramp portion,
wherein a first prong passage is arranged between the first shield portion and the first plate portion,
wherein a hole is arranged between the first plate portion and the first ramp portion,
wherein the first ramp portion has a first ramp face arranged thereon;
a second slider including a second shield portion, a second plate portion and a second ramp portion,
wherein a second prong passage is arranged between the second shield portion and the second plate portion,
wherein the second ramp portion has a second ramp face arranged thereon; and
at least one elastic element disposed on the first slider;
wherein the first and the second sliders are stacked alternatively with the second slider passing through the hole of the first slider, resting on top of the first plate portion, and in contact with the first shield portion,
wherein the first ramp portion is disposed on top of the second shield portion,
wherein the elastic element is flexible outward toward the second slider to allow the first and second sliders movably disposed in the housing, and the first and second ramp faces conform the position of the slots respectively.

12. The safety electric socket according to claim 11, wherein the elastic element is embedded in the first slider.

13. The safety electric socket according to claim 11, wherein the elastic element is a spring.

14. A safety electric socket comprising:
a main body with a housing;
a cap including at least two slots and covering the main body;
a first slider including a first shield portion, a first plate portion and a first ramp portion,
wherein a first prong passage is arranged between the first shield portion and the first plate portion,
wherein a hole is arranged between the first plate portion and the first ramp portion,
wherein the first ramp portion has a first ramp face arranged thereon;
a second slider including a second shield portion, a second plate portion and a second ramp portion,
wherein a second prong passage is arranged between the second shield portion and the second plate portion,
wherein the second ramp portion has a second ramp face arranged thereon; and
at least one elastic element disposed on the second slider;
wherein the first and the second sliders are stacked alternatively with the second slider passing through the hole of the first slider, resting on top of the first plate portion, and in contact with the first shield portion,
wherein the first ramp portion is disposed on top of the second shield portion,
wherein the elastic element is flexible outward toward the second slider to allow the first and second sliders movably disposed in the housing, and the first and second ramp faces conform the position of the slots respectively.

15. The safety electric socket according to claim 14, wherein the elastic element is embedded in the second slider.

16. The safety electric socket according to claim 14, wherein the elastic element is a spring.
